(19) United States
(12) Patent Application Publication
(10) Pub. No.: US 2024/0270915 A1
(43) Pub. Date: Aug. 15, 2024

(54) SILICA-COATED CELLULOSE NANOFIBER MODIFIED WITH HYDROPHOBIC FUNCTIONAL GROUP AND PRESSURE SENSITIVE ADHESIVE COMPRISING THE SAME

(71) Applicant: Kyungpook National University Industry-Academic Cooperation Foundation, Daegu (KR)

(72) Inventor: Dong Yun Lee, Suwon-si (KR)

(73) Assignee: Kyungpook National University Industry-Academic Cooperation Foundation, Daegu (KR)

(21) Appl. No.: 18/437,836

(22) Filed: Feb. 9, 2024

(30) Foreign Application Priority Data
Feb. 13, 2023 (KR) 10-2023-0019024

(51) Int. Cl. C08J 7/04; C09J 7/38; C09J 11/08

(52) U.S. Cl. CPC C08J 7/04; C09J 7/38; C09J 11/08; C08J 2301/02

(57) ABSTRACT

Provided are silica-coated cellulose nanofibers modified with a hydrophobic group capable of improving the mechanical properties of a pressure-sensitive adhesive while maintaining the adhesive performance of the pressure-sensitive adhesive; and a pressure-sensitive adhesive including the same.

### CROSS-REFERENCE TO RELATED APPLICATION

This application is based on and claims priority under 35 U.S.C. § 119 to Korean Patent Application No. 10-2023-0019024, filed on Feb. 13, 2023, in the Korean Intellectual Property Office, the disclosure of which is incorporated by reference herein in its entirety.

### BACKGROUND OF THE INVENTION

### Field of the Invention

The present invention relates to silica-coated cellulose nanofibers modified with a hydrophobic group capable of improving the mechanical properties of a pressure-sensitive adhesive while maintaining the adhesive performance of the pressure-sensitive adhesive; and a pressure-sensitive adhesive including the same.

Silica-coated cellulose nanofibers modified with a hydrophobic group according to the present invention have excellent compatibility and dispersibility with polymer materials, and so they can be used as fillers for polymer materials.

The pressure-sensitive adhesive including the silica-coated cellulose nanofibers modified with a hydrophobic group according to the present invention maintains transparency similar to that of a pressure-sensitive adhesive itself, and thus it can be used in products requiring optical transparency and it can have excellent adhesiveness and mechanical properties at the same time.

### DESCRIPTION OF THE RELATED ART

A pressure-sensitive adhesive (PSA) has an adhesive force by binding to a substrate when just a small pressure is applied to a surface, and through its natural cohesion and elasticity, it can be removed without contaminating an adherend after attachment. Unlike glues that become a solid through polymerization from a liquid to have adhesive strength, an adhesive is composed of a viscoelastic material, and it can be initially attached through its viscous properties, and it strongly adheres through elasticity and cohesion.

Pressure-sensitive adhesives are used in various industrial fields such as optical films, displays, packaging, and automobile industries. Recently, not only adhesives having adhesive performance, but also dissolvable adhesives, of which adhesiveness is decreased by heat and UV, and adhesives having new functions including optical, electrical, mechanical, thermal, and protective functions are being developed and applied industrially.

These adhesives may be broadly classified into rubber-based, silicone-based, and acrylic-based adhesives depending on the raw materials. Among them, acrylic adhesives have a wide range of applications because they have excellent physical properties such as the high optical transmittance, colorlessness, and chemical resistance of acrylic materials.

Generally, pressure-sensitive adhesives are classified into solvent-based, water-based, and solvent-free types (UV polymerization, hot melt). Recently, as interest in the environment has increased, the development has gradually shifted from solvent-based adhesives to emulsion-type, hot-melt, and UV-curable adhesives using water. Among them, UV-curable adhesives are drawing much industrial attention because they can be quickly polymerized through UV and they do not contain a solvent, thus releasing no volatile organic compounds.

UV-curable adhesives are manufactured through a two-step process of photopolymerizing monomers to produce a prepolymer and then photocrosslinking the same again.

Basically, the adhesive properties of an adhesive are determined by the monomer composition, molecular weight, and the content of a crosslinking agent. When the content of monomers having a high glass transition temperature (T_{g}) is increased to increase mechanical properties or when the cohesion of an adhesive itself is increased by increasing the molecular weight or the content of a crosslinking agent, the mobility of the adhesive molecular chain is limited, and the adhesive strength is thereby reduced. In other words, the mechanical properties and adhesive performance of an adhesive are in a trade-off relationship.

Meanwhile, a filler may be used as a method of improving the chemical and mechanical properties of a polymer material that makes up an adhesive, and the filler may also play the role of lowering the price of the adhesive.

Attempts are being made to improve the transparency, electrical characteristics, refractive index, and mechanical properties of adhesives by adding nanomaterials such as nano-clay, silica, TiO₂, and carbon nanotubes to the pressure-sensitive adhesives, but there are not many cases in which cellulose nanofibers (CNF) are used.

This is because cellulose nanofibers have hydrophilicity due to the large amount of hydroxyl groups (—OH) present on the surface, while the polymer materials, which are the main components of pressure-sensitive adhesive, have hydrophobicity. Therefore, it is difficult to disperse cellulose nanofibers in an adhesive and they do not sufficiently interact with polymer materials, thereby making it difficult to expect improvement in the mechanical properties.

### SUMMARY OF THE INVENTION

In the present invention, silica-coated cellulose nanofibers modified with a hydrophobic group were used as a filler to improve both the mechanical properties and adhesion of an adhesive at the same time. To increase the dispersibility of cellulose nanofibers and their interaction (affinity) with a polymer material, silica nanoparticles were formed on cellulose nanofibers and a functional group with hydrophobicity was introduced through surface modification of the silica nanoparticles.

The present invention provides cellulose nanofibers including silica nanoparticles coated on the cellulose nanofibers and a hydrophobic group bonded to the silica nanoparticles.

Since silica is coated on the cellulose nanofibers, the cellulose nanofibers according to the present invention can not only prevent aggregation of the cellulose nanofibers themselves but also introduce a hydrophobic group using a functional group present on the silica.

The hydrophobic group may include one or more compound selected from the group consisting of n-octadecyltrichlorosilane (ODTS), 3-(trimethoxysilyl)propyl methacrylate (Y-MPS), dodecyltrichlorosilane, trichloroethylsilane, trichloro(n-propyl) silane, trimethoxymethylsilane, triethoxymethylsilane, (3-phenylpropyl)methyldichlorosilane, methyltriethoxysilane, (3-phenylpropyl)methyldimethoxysilane, (3-phenylpropyl)methyldiethoxysilane, tris(trimethylsiloxy) chlorosilane, vinyl trimethoxysilane, vinyltriethoxysilane, vinyl-tris(β-methoxyethoxy) silane, Y-glycidoxypropyl-trimethoxysilane, (heptadecafluoro-1,1,2,2-tetrahydrodecyl)triethoxysilane (FAS), (heptadecafluoro-1,1,2,2-tetrahydrodecyl)trichlorosilane (FCS), n-decyltriethoxysilane (DTES), dimethoxydimethylsilane (DMDMS), and dimethoxydiphenylsilane (DMDPS), and in particular, n-octadecyltrichlorosilane (ODTS) or 3-(trimethoxysilyl)propyl methacrylate (γ-MPS) is preferred.

In the silica-coated cellulose nanofibers modified with a hydrophobic group according to the present invention, the aggregation of the nanofibers themselves is decreased by silica coating and the compatibility and dispersibility with polymer materials are increased due to the surface-modified hydrophobic group on the silica. Therefore, the silica-coated cellulose nanofibers can be used in various polymer materials to form a polymer composition. A preferred polymer composition may be a pressure-sensitive adhesive.

The silica-coated cellulose nanofibers modified with a hydrophobic group according to the present invention may be prepared by a step of dispersing cellulose nanofibers in an alcohol solvent; a step of forming silica nanoparticles on the surface of the dispersed cellulose nanofibers, and a step of binding a hydrophobic group to the silica nanoparticles.

The silica-coated cellulose nanofibers modified with a hydrophobic group according to the present invention have excellent dispersibility and compatibility with polymer materials, so they can be used as a filler for a polymer material, and a pressure-sensitive adhesive including the silica-coated cellulose nanofibers modified with a hydrophobic group exhibits improved mechanical properties while maintaining the adhesiveness of the pressure-sensitive adhesive itself, and it also maintains the transparency of the pressure-sensitive adhesive itself.

### BRIEF DESCRIPTION OF THE DRAWINGS

FIG. 1 shows a preparation process of cellulose nanofibers surface-modified with a hydrophobic group;

FIG. 2 shows the SEM images of cellulose nanofibers (CNF), silica nanoparticle-coated cellulose nanofibers (CNF-SiO₂) and silica-coated cellulose nanofibers modified with a hydrophobic group (CNF-SiO₂-MPS and CNF-SiO₂-ODTS);

FIG. 3 shows the FT-IR measurement results of silica nanoparticle-coated cellulose nanofibers (CNF-SiO₂) and silica-coated cellulose nanofibers modified with a hydrophobic group (CNF-SiO₂-MPS);

FIG. 4 shows the FT-IR measurement results of silica nanoparticle-coated cellulose nanofibers (CNF-SiO₂) and silica-coated cellulose nanofibers modified with a hydrophobic group (CNF-SiO₂-ODTS);

FIG. 5 shows a process of manufacturing a pressure-sensitive adhesive film from a prepolymer;

FIG. 6 shows the results of polarizing microscopy of pressure-sensitive adhesive films;

FIG. 7 shows the results of measuring the gel fraction of UV cross-linked pressure-sensitive adhesive films;

FIG. 8 shows the results of measuring the tensile strength of UV cross-linked pressure-sensitive adhesive films;

FIG. 9 shows the results of measuring the 180-degree peel adhesive force (peel strength) and SUS probe tack adhesive force of UV cross-linked pressure-sensitive adhesive films; and

FIG. 10 shows the results of measuring the transparency of UV cross-linked pressure-sensitive adhesive films.

### DETAILED DESCRIPTION OF THE EMBODIMENTS

The terms used in the present specification is intended to describe embodiments and are not intended to limit the present invention. In the present specification, singular forms also include plural forms, unless specifically stated otherwise in the context. As used in the specification, “comprises” does not exclude the presence or addition of one or more other elements in addition to the mentioned elements.

Unless otherwise defined, all terms (including technical and scientific terms) used in the present specification may be used with meanings commonly understood by those skilled in the art to which the present invention pertains. In addition, terms defined in commonly used dictionaries are not to be interpreted ideally or excessively unless clearly specifically defined.

Hereinafter, embodiments of the present invention will be described in detail with reference to the attached drawings so that those skilled in the art may easily implement the invention. However, the present invention may be implemented in many different forms and is not limited to the embodiments described herein.

Hereinafter, a method of preparing silica-coated cellulose nanofibers modified with a hydrophobic group according to the present invention is described as follows.

### (1) Preparation of Silica-Coated Cellulose Nanofibers (CNF-SiO₂)

Cellulose nanofibers (CNF) dispersed in water are solvent-exchanged with ethanol using a centrifuge, and then the cellulose nanofibers are redispersed in ethanol using ultrasound.

Silica nanoparticles are formed on the surface of the dispersed cellulose nanofibers using a sol-gel process (Stöber process).

In one embodiment, 20 g of a cellulose nanofiber (average diameter: 40 nm) solution (0.5 wt. %) and 0.455 ml of NH₄OH, which acts as a catalyst, were added to a 100 ml vial and stirred at 400 rpm for 24 h. After the stirring, 0.85 ml of tetraethyl orthosilicate (TEOS) was slowly added at a rate of 250 μl/min using a syringe pump, and the reaction mixture was allowed to react for two hours. Cellulose nanofibers on which silica nanoparticles were formed were separated using a centrifuge and then dispersed again in 40 ml of ethanol.

(2) Preparation of Silica-Coated Cellulose Nanofibers Modified with a Hydrophobic Group

As Example 1, 0.2 ml of 0.5% by volume of 3-(trimethoxysilyl)propyl methacrylate (γ-MPS) was added to 40 ml of the silica nanoparticle-coated cellulose nanofiber (CNF-SiO₂) solution prepared in Step (1) above, and the resulting mixture was stirred for six hours. After the stirring, the reaction mixture was washed two to three times with distilled water and centrifuged. Silica-coated cellulose nanofibers (CNF-SiO₂-MPS) surface-modified with a hydrophobic group (MPS) are obtained in the form of solid particles by freeze-drying at −50° C.

As Example 2, silica-coated cellulose nanofibers (CNF-SiO₂-ODTS) surface-modified with a hydrophobic group (ODTS) were obtained in the same manner as above, except that n-octadecyltrichlorosilane (ODTS) was used instead of Y-MPS.

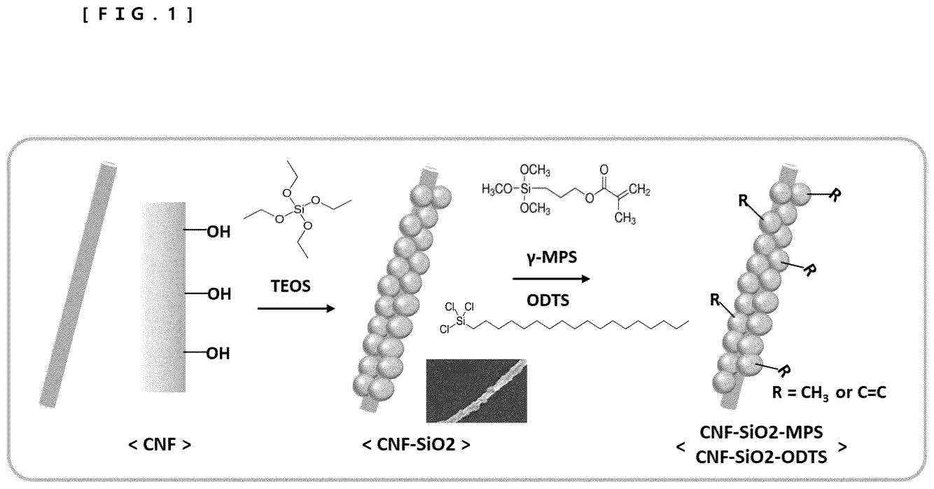

FIG. 1 shows a preparation process of cellulose nanofibers surface-modified with a hydrophobic group.

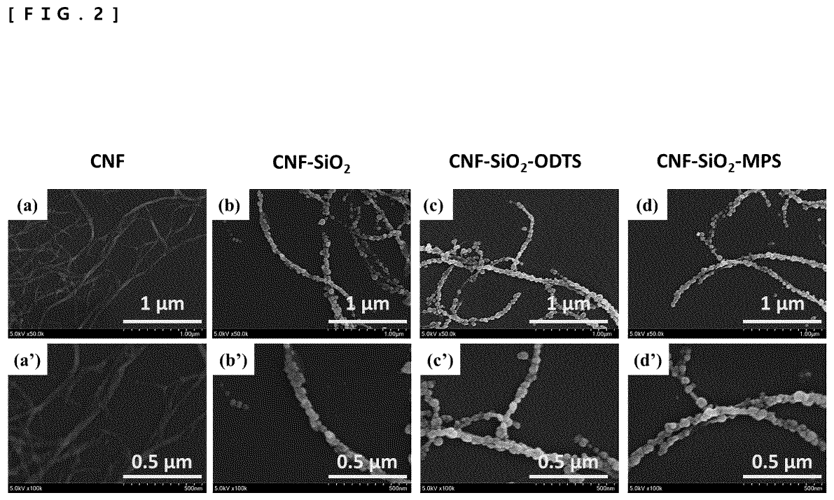

FIG. 2 shows the SEM images of cellulose nanofibers (CNF), silica nanoparticle-coated cellulose nanofibers (CNF-SiO₂) and silica-coated cellulose nanofibers modified with a hydrophobic group (CNF-SiO₂-MPS and CNF-SiO₂-ODTS).

As shown in FIG. 2, it can be confirmed that spherical silica nanoparticles are formed on the cellulose nanofibers through Step (1) above (see FIGS. 2(b) and 2(b′)). It can be confirmed that as silica nanoparticles are formed on the cellulose nanofibers, the aggregation of cellulose nanofibers decreases, and the distance between nanofibers further increases.

Due to this increase of the distance between nanofibers, surface modification of the cellulose nanofibers can be easily performed. In other words, since cellulose nanofibers have high self-aggregation properties and high hydrophilicity, it is not easy to introduce a hydrophobic surface modifier directly into the cellulose nanofibers. However, as in the present invention, by introducing a silica coating to cellulose nanofibers to reduce the aggregation of cellulose nanofibers, it becomes easier to introduce a hydrophobic surface modifier. In addition, since silica includes reactive groups on the surface, it becomes easier to introduce a hydrophobic surface modifier by using the reactive groups.

In addition, an increase of the distance between nanofibers may reduce the self-aggregation of cellulose nanofibers, thereby contributing to the improvement of the dispersibility of the nanofibers.

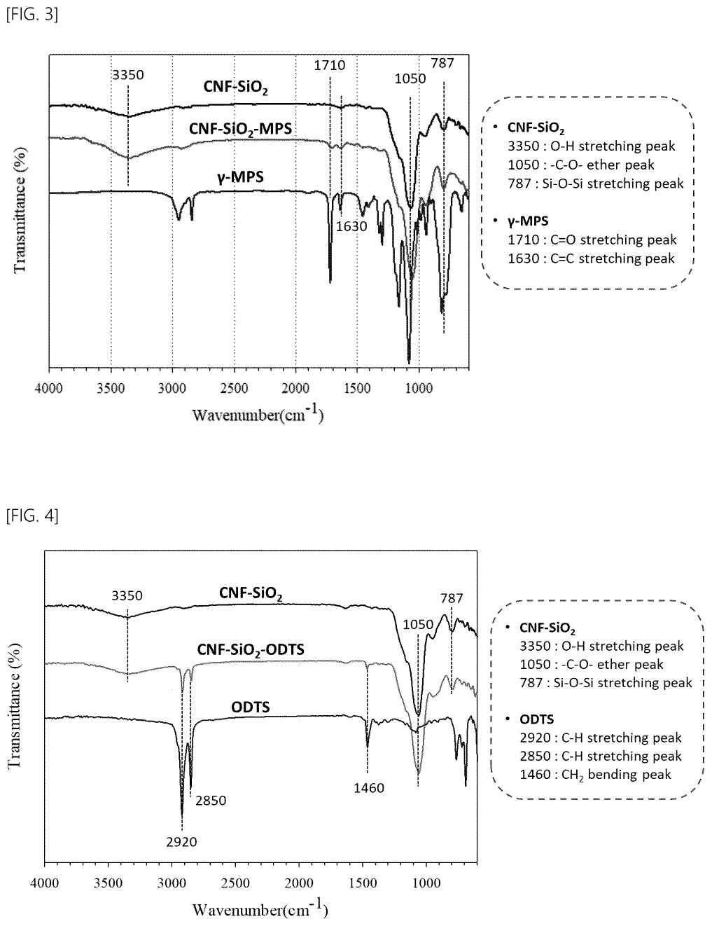

FIGS. 3 and 4 show the FT-IR measurement results of silica nanoparticle-coated cellulose nanofibers (CNF-SiO₂) and silica-coated cellulose nanofibers modified with a hydrophobic group (CNF-SiO₂-MPS and CNF-SiO₂-ODTS). It can be confirmed that silica nanoparticles were formed on the cellulose nanofibers through Steps (1) and (2), and a hydrophobic surface modifier was introduced onto the silica nanoparticles.

In Examples 1 and 2, it was described that n-octadecyltrichlorosilane (ODTS) and 3-(trimethoxysilyl)propyl methacrylate (γ-MPS) were used as hydrophobic surface modifiers, but any material that is reactive with a hydroxyl group (—OH) of silica and that can provide cellulose nanofibers with the affinity to a polymer material may be used as the surface modifier without limitation. The surface modifier may be at least one selected from the group consisting of dodecyltrichlorosilane, trichloroethylsilane, trichloro(n-propyl) silane, trimethoxymethylsilane, triethoxymethylsilane, (3-phenylpropyl)methyldichlorosilane, methyltriethoxysilane, (3-phenylpropyl)methyldimethoxysilane, (3-phenylpropyl)methyldiethoxysilane, tris(trimethylsiloxy) chlorosilane, vinyl trimethoxysilane, vinyltriethoxysilane, vinyl-tris(β-methoxyethoxy) silane, γ-glycidoxypropyl-trimethoxysilane, (heptadecafluoro-1,1,2,2-tetrahydrodecyl)triethoxysilane (FAS), (heptadecafluoro-1,1,2,2-tetrahydrodecyl)trichlorosilane (FCS), n-decyltriethoxysilane (DTES), dimethoxydimethylsilane (DMDMS), and dimethoxydiphenylsilane (DMDPS), but it is not limited thereto.

When the cellulose nanofibers coated with silica nanoparticles modified with a hydrophobic group according to the present invention are used as fillers in polymer materials, they can improve the mechanical properties of the polymer materials due to improved dispersibility by a hydrophobic surface modifier, improved interaction with polymer materials, and reinforcing effect of the nanofibers themselves. In particular, when used in a pressure-sensitive adhesive, they can improve the mechanical properties without reducing adhesive performance.

Hereinafter, an example of using the silica-coated cellulose nanofibers modified with a hydrophobic group according to the present invention as a filler for a pressure-sensitive adhesive will be described.

### (3) Manufacturing of Prepolymer and Pressure-Sensitive Adhesive Film

1-Hydroxy-cyclohexylphenyl ketone (Irgacure 184) was added as a photoinitiator in an amount of 0.05 parts by weight based on 100 parts by weight of a monomer mixture of 75% by weight of 2-ethylhexyl acrylate (2-EHA), 5% by weight of acrylic acid (AA), and 20% by weight of isobornyl acrylate (IBOA), and the resulting mixture was placed in a 500 ml, 4-necked flask. The oxygen in the mixture was removed by replacing with nitrogen for 30 min. While stirred at 200 rpm, the mixture was irradiated with 365 nm UV to produce a prepolymer by photopolymerization.

The prepolymer was mixed with a photoinitiator, cellulose nanofibers, silica-coated cellulose nanofibers, or silica-coated cellulose nanofibers modified with a hydrophobic group, and a curing agent (hexanediol diacrylate, HDDA) are mixed. After adding 0.05 to 1.0 parts by weight of the nanofibers to 20 g of the prepolymer, the nanofibers were dispersed in the prepolymer for 30 min using a stirrer (vortex mixer) and an ultrasonicator (tip-ultrasonicator, 20 s/10 s pulse).

The prepolymer mixture including the nanofibers was applied to a 100 μm thickness on a 25 μm-thick corona surface-treated PET film and then cured using a UV lamp to manufacture a pressure-sensitive adhesive film. UV with an intensity of 3.2 mW/cm² was irradiated for ten minutes, the total amount of UV irradiated was 2000 mJ/cm², and the thickness of the final film was about 100±10 μm.

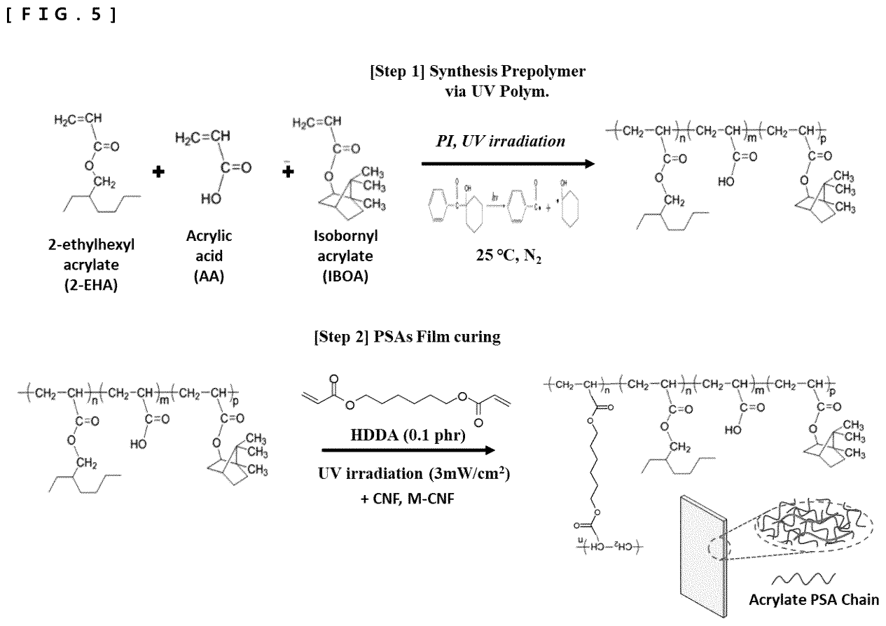

Table 1 below shows the composition of the pressure-sensitive adhesive film manufactured using the prepolymer, and FIG. 5 shows the process of manufacturing the pressure-sensitive adhesive film from the prepolymer.

TABLE 1
Unit: Parts by weight

| | | | | CNF— | CNF— |
|---|---|---|---|---|---|
| | | | CNF— | SiO₂— | SiO₂— |
| | Prepolymer | CNF | SiO₂ | MPS | ODTS |
| Comparative | 100 | — | — | — | — |
| Example 1 | | | | | |
| Comparative | 100 | 0.05 | | | |
| Example 2 | | | | | |
| Comparative | | 0.1 | | | |
| Example 3 | | | | | |
| Comparative | | 0.3 | | | |
| Example 4 | | | | | |
| Comparative | | 0.5 | | | |
| Example 5 | | | | | |
| Comparative | | 1.0 | | | |
| Example 6 | | | | | |
| Comparative | | | 0.05 | | |
| Example 7 | | | | | |
| Comparative | | | 0.1 | | |
| Example 8 | | | | | |
| Comparative | | | 0.3 | | |
| Example 9 | | | | | |
| Comparative | | | 0.5 | | |
| Example 10 | | | | | |
| Comparative | | | 1.0 | | |
| Example 11 | | | | | |
| Example 3 | | | | 0.05 | |
| Example 4 | | | | 0.1 | |
| Example 5 | | | | 0.3 | |
| Example 6 | | | | 0.5 | |
| Example 7 | | | | 1.0 | |
| Example 8 | | | | | 0.05 |
| Example 9 | | | | | 0.1 |
| Example 10 | | | | | 0.3 |
| Example 11 | | | | | 0.5 |
| Example 12 | | | | | 1.0 |

CNF; cellulose nanofibers

CNF-SiO₂; silica nanoparticle-coated cellulose nanofibers

CNF-SiO₂-MPS; silica-coated cellulose nanofibers modified with MPS

CNF-SiO₂-ODTS; silica-coated cellulose nanofibers modified with ODTS

Hereinafter, the physical properties of the pressure-sensitive adhesive film manufactured in (3) above will be described.

### (4) Dispersity Properties

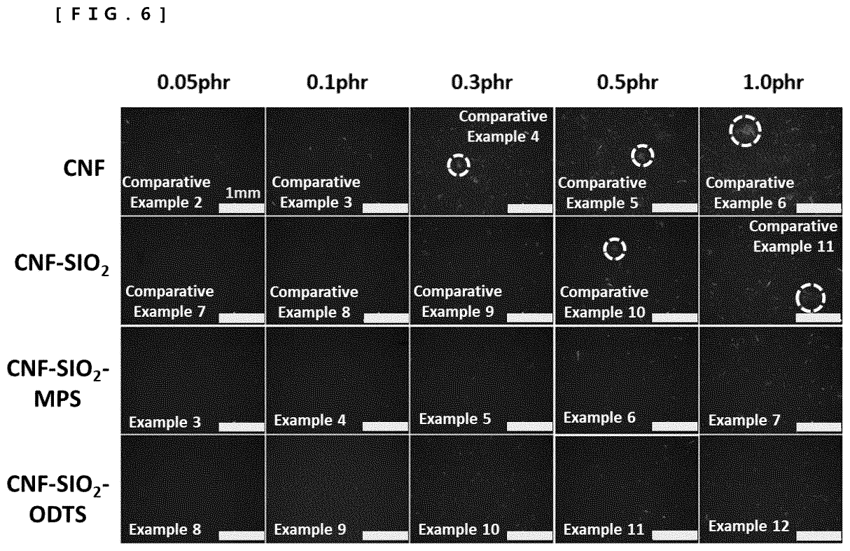

FIG. 6 shows the results of polarizing microscopy of pressure-sensitive adhesive films. In the unmodified cellulose nanofibers (see Comparative Examples 2 to 6), aggregation between nanofibers occurred as the content increased from 0.3 parts by weight, and in the case of the silica-coated cellulose nanofibers (see Comparative Examples 7 to 11), an aggregation phenomenon was observed beginning from 0.5 parts by weight.

In contrast, cellulose nanofibers surface-modified with hydrophobic groups (see Examples 3 to 12) show relatively good dispersibility with respect to the total content.

### (5) Curing Properties

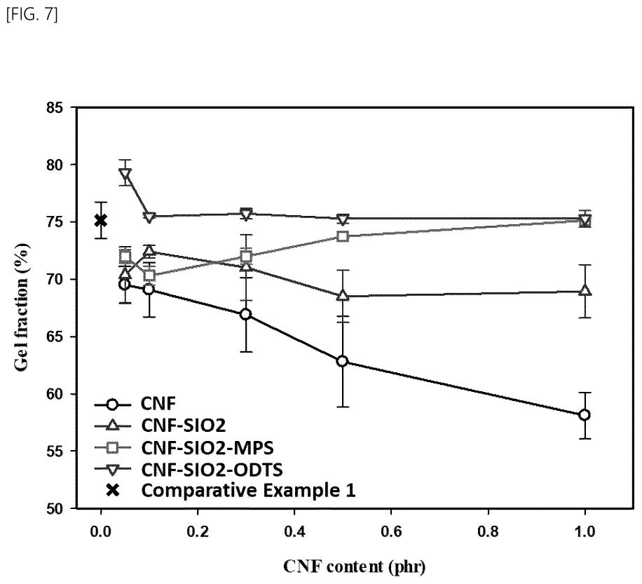

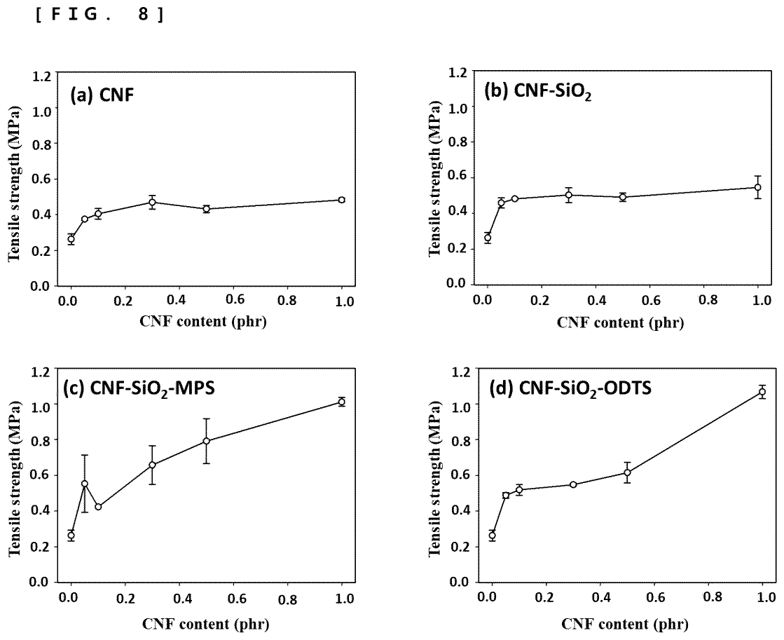

FIG. 7 shows the results of measuring the gel fraction of UV cross-linked pressure-sensitive adhesive films. 0.2 g of the crosslinked film was dissolved in toluene for 24 h, and after filtering undissolved components through a 200 mesh filter, dried at 80° C. for 12 h, and the remaining weight was measured to determine the gel fraction.

Comparative Example 1 without adding cellulose nanofibers showed a gel fraction of about 75%, and upon the addition of cellulose nanofibers, the gel fraction decreases as the content increases, and when 1.0 parts by weight, which is the maximum content, was added (Comparative Example 6), the gel fraction was about 57%, indicating that the gel fraction was reduced to about 24% compared to Comparative Example 1. This is thought to be because aggregation of nanofibers occurs as the content of cellulose nanofibers increases, and the aggregated nanofibers impede the transmission of UV light during the curing step, thereby disrupting the curing reaction.

On the other hand, in the case of silica-coated nanofibers (see Comparative Examples 7 to 11), the gel fraction decreased compared to Comparative Example 1, but did not exhibit a drastic decrease as in Comparative Examples 2 to 6. This is because the aggregation of the nanofibers themselves was reduced by the silica formed on the nanofiber surface.

It can be seen that the gel fraction is increased by the addition of the silica-coated cellulose nanofibers modified with hydrophobic groups. This is believed to be because, in the case of the modification with 3-(trimethoxysilyl)propyl methacrylate (γ-MPS), the concentration of crosslinks generated within the polymer matrix increased due to the double bond at the end of MPS, and in the case of the modification with n-octadecyltrichlorosilane (ODTS), the dispersibility of the nanofibers was excellent.

In particular, the improvement in gel fraction was higher when the nanofibers surface-modified with ODTS were used compared to those surface-modified with γ-MPS.

### (6) Mechanical Properties

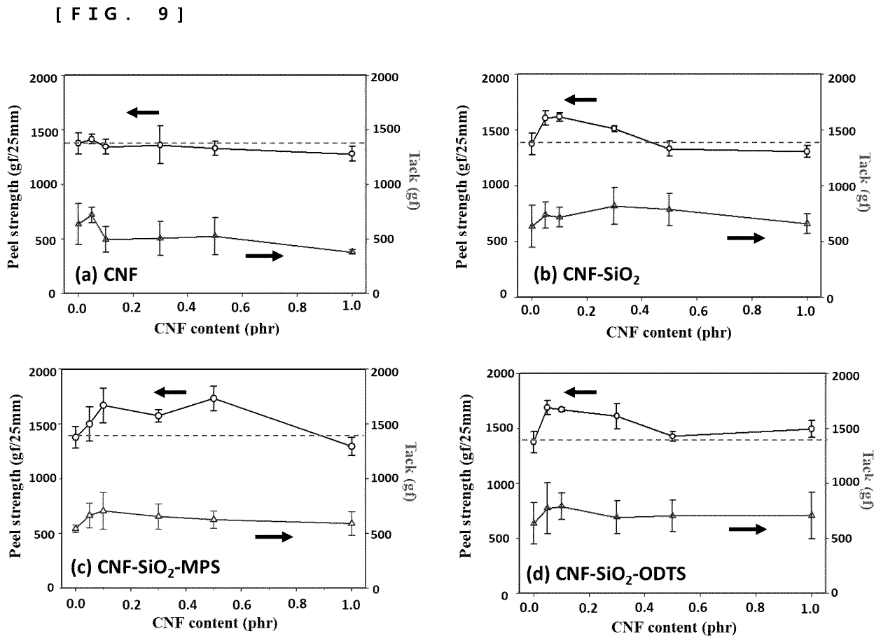

FIG. 8 shows the results of measuring the tensile strength of UV cross-linked pressure-sensitive adhesive films.

The tensile strength increased as the content of cellulose nanofibers added as a filler increased. As shown in FIGS. 8(a) and 8(b), the improvement in tensile strength due to the silica-coated nanofibers is not very significant. However, the silica-coated nanofibers surface-treated with hydrophobic groups (see FIGS. 8(c) and 8(d)) exhibited a significant tensile strength improvement effect. This improvement in tensile strength is believed to be the result of increased interaction with the prepolymer by the hydrophobic group and improved dispersibility.

### (7) Adhesion Properties

FIG. 9 shows the results of measuring the 180-degree peel adhesive force (peel strength) and SUS probe tack adhesive force of UV cross-linked pressure-sensitive adhesive films. The dotted line in FIG. 9 represents the adhesive force of Comparative Example 1.

As shown in FIG. 9(a), the addition of cellulose nanofibers reduces the adhesive force of the pressure-sensitive adhesive films. This is believed to be due to not only low dispersibility of the nanofibers, but also a decrease of the degree of cross-linking (gel fraction), resulting in a decrease in cohesive force and wetting.

In the case of the silica-coated nanofibers, the adhesive force is improved or has a similar value compared to Comparative Example 1 up to about 0.5 parts by weight (see FIG. 9(b)).

In the case of the cellulose nanofibers modified with γ-MPS, the adhesive force is improved or has a similar value compared to Comparative Example 1 up to about 0.9 parts by weight (see FIG. 9(c)), and the cellulose nanofibers modified with ODTS exhibit a better adhesive force than that of Comparative Example 1 in the entire content range (see FIG. 9(d)).

### (8) Optical Properties

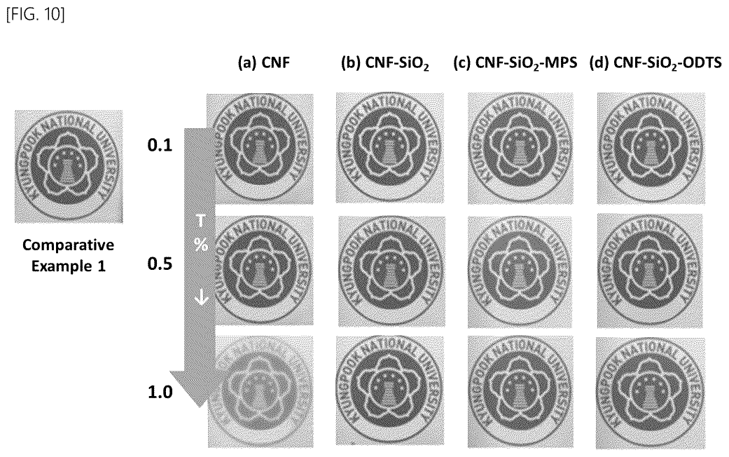

FIG. 10 shows the results of measuring the transparency of UV cross-linked pressure-sensitive adhesive films.

It can be confirmed that when unmodified cellulose nanofibers were added, the transparency decreased as the added amount increased (see FIG. 10(a)). However, it can be seen that when silica-coated nanofibers or silica-coated cellulose nanofibers surface-treated with a hydrophobic group were added, the decrease in transparency was not significant.

As described above, the silica-coated cellulose nanofibers modified with a hydrophobic group according to the present invention can improve both the mechanical properties and adhesive strength of the pressure-sensitive adhesive film at the same time, and have no significant effect on the transparency of the film.

Therefore, the adhesive including the silica-coated cellulose nanofibers modified with a hydrophobic group according to the present invention can be used in products that are optically transparent and that require both mechanical properties and adhesive force.

What is claimed is:

1. Cellulose nanofibers comprising silica nanoparticles coated on the cellulose nanofibers and a hydrophobic group bonded to the silica nanoparticles.

2. The cellulose nanofibers according to claim 1, wherein the hydrophobic group includes one or more compound selected from the group consisting of n-octadecyltrichlorosilane (ODTS), 3-(trimethoxysilyl)propyl methacrylate (γ-MPS), dodecyltrichlorosilane, trichloroethylsilane, trichloro(n-propyl) silane, trimethoxymethylsilane, triethoxymethylsilane, (3-phenylpropyl)methyldichlorosilane, methyltriethoxysilane, (3-phenylpropyl)methyldimethoxysilane, (3-phenylpropyl)methyldiethoxysilane, tris(trimethylsiloxy) chlorosilane, vinyl trimethoxysilane, vinyltriethoxysilane, vinyl-tris(β-methoxyethoxy) silane, γ-glycidoxypropyl-trimethoxysilane, (heptadecafluoro-1,1,2,2-tetrahydrodecyl)triethoxysilane (FAS), (heptadecafluoro-1,1,2,2-tetrahydrodecyl)trichlorosilane (FCS), n-decyltriethoxysilane (DTES), dimethoxydimethylsilane (DMDMS), and dimethoxydiphenylsilane (DMDPS).

3. The cellulose nanofibers according to claim 2, wherein the hydrophobic group is n-octadecyltrichlorosilane (ODTS) or 3-(trimethoxysilyl)propyl methacrylate (γ-MPS).

4. A polymer composition comprising cellulose nanofibers of claim 1.

5. The polymer composition according to claim 4, wherein the polymer composition is a pressure-sensitive adhesive.

6. A method of preparing the cellulose nanofibers according to claim 1, the method comprising:
a step of dispersing cellulose nanofibers in an alcohol solvent;
a step of forming silica nanoparticles on the surface of the dispersed cellulose nanofibers; and
a step of binding a hydrophobic group to the silica nanoparticles.
